(19) United States
(12) Patent Application Publication
(10) Pub. No.: US 2024/0221981 A1
(43) Pub. Date: Jul. 4, 2024

(54) ELECTRONIC COMPONENT AND FILM FORMING METHOD

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP)

(21) Appl. No.: 18/608,018

(22) Filed: Mar. 18, 2024

Related U.S. Application Data
(63) Continuation of application No. PCT/JP2023/023393, filed on Jun. 23, 2023.

(30) Foreign Application Priority Data
Aug. 31, 2022 (JP) 2022-137882

(51) Int. Cl. H01C 1/034; H01C 17/02

(52) U.S. Cl. CPC H01C 1/034; H01C 17/02

(57) ABSTRACT

An electronic component that includes: a base body having an outer surface, and the outer surface having a recess that is a site recessed with respect to a periphery of the outer surface; and a glass film that covers at least a portion of the outer surface of the base body having the recess, wherein a part of the glass film that covers the recess is recessed with respect to the periphery of the outer surface of the glass film, and a ratio of a minimum value of a thickness of the glass film covering the recess to a maximum value of the thickness is 0.05 to 0.8.

### CROSS REFERENCE TO RELATED APPLICATIONS

The present application is a continuation of International application No. PCT/JP2023/023393, filed Jun. 23, 2023, which claims priority to Japanese Patent Application No. 2022-137882, filed Aug. 31, 2022, the entire contents of each of which are incorporated herein by reference.

### TECHNICAL FIELD

The present disclosure relates to an electronic component and a film forming method.

### BACKGROUND ART

The electronic component described in Patent Document 1 includes a base body, a glass film, and an underlying electrode. The base body is made of a ceramic. The glass film covers the outer surface of the base body. The underlying electrode covers a part of the outer surface of the glass film. Further, the underlying electrode is electrically connected to an internal electrode in the base body.

In the electronic component, the base body has a rectangular parallelepiped shape. Thus, the base body has, as the outer surface, six surface parts and side parts that are boundaries between the adjacent surface parts. Further, the thickness of the glass film covering the side parts is smaller than the thickness of the glass film covering the surface parts.
Patent Document 1: Japanese Patent No. 5835047

### SUMMARY OF THE INVENTION

In such an electronic component as described in Patent Document 1, the outer surface of the base body may have a recess recessed with respect to other part. When the glass film is to be formed on the outer surface with such a recess as described above, the thickness of the glass film covering the vicinity of an opening edge of the recess will be significantly smaller than the thickness of the glass film covering the recess. Further, when the thickness of the glass film has a sharp change at a specific site, stress will be concentrated on the side, thereby making the glass film likely to cause cracks and the like.

An electronic component according to an aspect of the present disclosure includes: a base body having an outer surface, and the outer surface having a recess that is a site recessed with respect to a periphery of the outer surface; and a glass film that covers at least a portion of the outer surface of the base body having the recess, wherein a part of the glass film covering the recess is recessed with respect to the periphery of the outer surface of the glass film, and a ratio of a minimum value of a thickness of the glass film covering the recess to a maximum value thereof is 0.05 to 0.8.

In addition, a film forming method according to another aspect of the present disclosure is a film forming method for forming a glass film containing a metal oxide on a surface of a base body, including: placing the base body into a reaction vessel; placing a metal alkoxide or a metal alkoxide precursor into the reaction vessel; placing a catalyst that promotes hydrolysis of the metal alkoxide into the reaction vessel; forming the glass film on the surface of the base body by hydrolyzing and dehydrating and condensing the metal alkoxide; a first drying of the glass film after the forming of the glass film; immersing the base body in a solution of an additive containing at least one element selected from an alkali metal and an alkaline earth metal after the first drying of the glass film; a second drying of the glass film after the immersing of the base body in the solution; and curing the glass film by firing the glass film after the second drying of the glass film.

In accordance with the configuration mentioned above, the ratio of the minimum value of the thickness of the glass film covering the recess to the maximum value thereof is 0.05 to 0.8. In this regard, the glass film covering the recess has a maximum thickness at a site that covers the vicinity of the deepest part of the recess. In contrast, the glass film covering the recess has a minimum thickness at a site that covers the vicinity of an opening edge of the recess. More specifically, the change in the thickness of the glass film covering the recess is not sharp from the deepest part of the recess to the opening edge of the recess. Accordingly, the glass film covering the recess can be prevented from being cracked or the like.

The glass film covering the recess can be prevented from being cracked or the like.

### BRIEF EXPLANATION OF THE DRAWINGS

FIG. 1 is a perspective view of an electronic component.

FIG. 2 is a sectional view of an XY plane passing through a central axis CA in FIG. 1.

FIG. 3 is an enlarged sectional view of a recess and the vicinity thereof.

FIG. 4 is a flowchart illustrating a method for manufacturing an electronic component.

FIG. 5 is an explanatory diagram illustrating the method for manufacturing an electronic component.

FIG. 6 is an explanatory diagram illustrating the method for manufacturing an electronic component.

FIG. 7 is an explanatory diagram illustrating the method for manufacturing an electronic component.

FIG. 8 is an explanatory diagram illustrating the method for manufacturing an electronic component.

FIG. 9 is an explanatory diagram illustrating the method for manufacturing an electronic component.

FIG. 10 is an explanatory diagram illustrating the method for manufacturing an electronic component.

### DETAILED DESCRIPTION OF THE INVENTION

### <Embodiment of Electronic Component>

Hereinafter, an embodiment of an electronic component will be described with reference to the drawings. It is to be noted that the drawings may show enlarged components for the sake of easy understanding. The dimensional ratios of the components may be different from the actual ones or those in another drawing.

### (As for Overall Configuration)

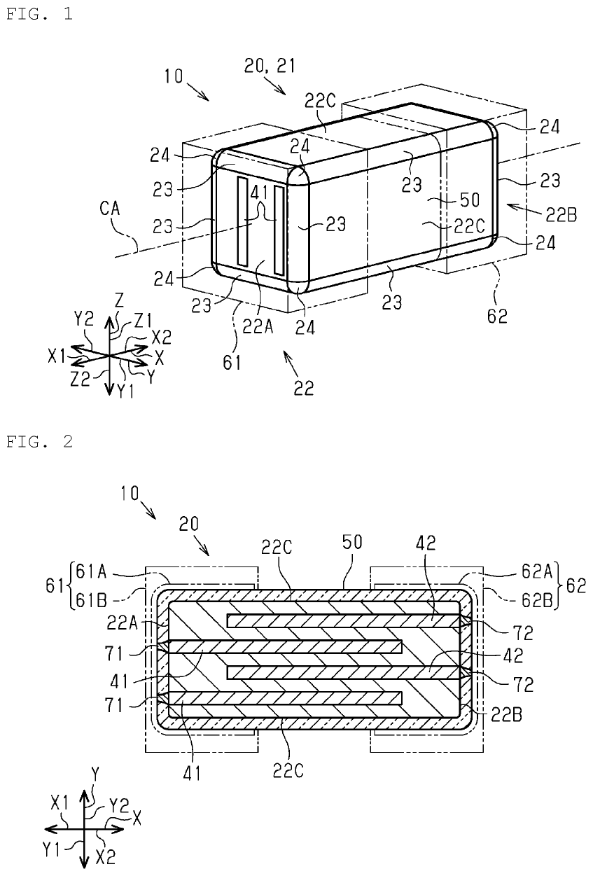

As shown in FIG. 1, an electronic component 10 is, for example, a surface mount negative characteristic thermistor component that is mounted on a circuit board or the like. It is to be noted that the negative characteristic thermistor component has a characteristic that the resistance value is decreased as the temperature is increased.

The electronic component 10 includes a base body 20. The base body 20 has a substantially quadrangular columnar shape and has a central axis CA. Hereinafter, an axis extending along the central axis CA is defined as a first axis X. In addition, one of axes that are orthogonal to the first axis X is defined as a second axis Y. Further, an axis that is orthogonal to both the first axis X and the second axis Y is defined as a third axis Z. Furthermore, one of the directions along the first axis X is defined as a first positive direction X1, and the direction opposite to the first positive direction X1, of the directions along the first axis X, is defined as a first negative direction X2. In addition, one of the directions along the second axis Y is defined as a second positive direction Y1, and the direction opposite to the second positive direction Y1, of the directions along the second axis Y, is defined as a second negative direction Y2. Furthermore, one of the directions along the third axis Z is defined as a third positive direction Z1, and the direction opposite to the third positive direction Z1, of the directions along the third axis Z, is defined as a third negative direction Z2.

An outer surface 21 of the base body 20 has six flat faces 22. It is to be noted that the term “face” of the base body 20 as used herein refers to a part that can be observed as a face when the whole base body 20 is observed. More specifically, for example, if there are such minute irregularities or steps that fail to be found unless a part of the base body 20 is enlarged and then observed with a microscope or the like, the face is expressed as a flat face or a curved face. The six flat faces 22 face in directions that are different from each other. The six flat faces 22 are roughly divided into a first end surface 22A that faces in the first positive direction X1, a second end surface 22B that has in the first negative direction X2, and four side surfaces 22C. The four side surfaces 22C are a surface that faces in the third positive direction Z1, a surface that faces in the third negative direction Z2, a surface that faces in the second positive direction Y1, and a surface that faces in the second negative direction Y2.

The outer surface 21 of the base body 20 has twelve boundary surfaces 23. The boundary surface 23 includes a curved surface that is present at the boundary between the adjacent flat faces 22. More specifically, the boundary surface 23 includes, for example, a curved surface formed by round chamfering of a corner formed by the adjacent flat faces 22.

In addition, the outer surface 21 of the base body 20 has eight spherical corner surfaces 24. The corner surface 24 is a boundary part between the three adjacent flat faces 22. In other words, the corner surface 24 includes a curved surface at a position where the three boundary surfaces 23 intersect. More specifically, the corner surface 24 includes, for example, a curved surface formed by round chamfering of a corner formed by the three adjacent flat faces 22. It is to be noted that a surface of a glass film 50 to be described later is designated by the same reference numerals as with the outer surface 21 of the base body 20 in FIG. 1.

As shown in FIG. 1, the base body 20 is larger in dimension in the direction along the first axis X than in dimension in the direction along the third axis Z. In addition, the base body 20 is larger in dimension in the direction along the first axis X than in dimension in the direction along the second axis Y. In addition, the material of the base body 20 is a ceramic obtained by firing a metal oxide containing one or more selected from Mn, Fe, Ni, Co, Ti, Ba, Al, and Zn as a component.

As shown in FIG. 2, the electronic component 10 includes two first internal electrodes 41 and two second internal electrodes 42. The first internal electrodes 41 and the second internal electrodes 42 are embedded in the base body 20.

The material of the first internal electrodes 41 is a conductive material. For example, the material of the first internal electrodes 41 is palladium. In addition, the material of the second internal electrodes 42 is the same as the material of the first internal electrodes 41.

The first internal electrode 41 has a rectangular plate shape. A main surface of the first internal electrode 41 is orthogonal to the second axis Y. The second internal electrode 42 has the same rectangular plate shape as the first internal electrode 41. A main surface of the second internal electrode 42 is orthogonal to the second axis Y, as with the first internal electrode 41.

The dimension of the first internal electrode 41 in the direction along the first axis X is smaller than the dimension of the base body 20 in the direction along the first axis X. In addition, as shown in FIG. 1, the dimension of the first internal electrode 41 in the direction along the third axis Z is approximately ⅔ of the dimension of the base body 20 in the direction along the third axis Z. The dimensions of the second internal electrode 42 in each of the directions are the same as those of the first internal electrode 41.

As shown in FIG. 2, the first internal electrodes 41 and the second internal electrodes 42 are located in a staggered manner in the direction along the second axis Y. More specifically, the first internal electrode 41, the second internal electrode 42, the first internal electrode 41, and the second internal electrode 42 are arranged in this order toward the second negative direction Y2 from the side surface 22C that faces in the second positive direction Y1. According to this embodiment, the distances between the respective internal electrodes in the direction along the second axis Y are equal to each other.

As shown in FIG. 1, the two first internal electrodes 41 and the two second internal electrodes 42 are both located at the center of the base body 20 in the direction along the third axis Z. In contrast, as shown in FIG. 2, the first internal electrodes 41 are located to be shifted in the first positive direction X1. The second internal electrodes 42 are located to be shifted in the first negative direction X2.

Specifically, an end of the first internal electrode 41 in the first positive direction X1 coincides with an end of the base body 20 in the first positive direction X1. The end of the first internal electrode 41 in the first negative direction X2 is located inside the base body 20, and does not reach the end of the base body 20 in the first negative direction X2. In contrast, an end of the second internal electrode 42 in the first negative direction X2 coincides with the end of the base body 20 in the first negative direction X2. The end of the second internal electrode 42 in the first positive direction X1 is located inside the base body 20, without reaching the end of the base body 20 in the first positive direction X1.

As shown in FIG. 2, the electronic component 10 includes the glass film 50. The glass film 50 covers the outer surface 21 of the base body 20. According to the present embodiment, the glass film 50 covers the whole region of the outer surface 21 of the base body 20. The main material of the glass film 50 is insulating glass. Thus, the glass film 50 contains a silicon dioxide. In addition, the glass film 50 contains, as an additive, one or more elements selected from alkali metals and alkaline earth metals. Specifically, the glass film 50 contains potassium as an additive. The value of “K/Si”, which is the ratio of potassium to silicon contained in the glass film 50, is 0.5 atm % to 90 atm %. Specifically, the ratio of potassium to silicon contained in the glass film 50 is about 30 atm %.

The electronic component 10 includes a first external electrode 61 and a second external electrode 62. The first external electrode 61 includes a first underlying electrode 61A and a first metal layer 61B. The first underlying electrode 61A is stacked on the glass film 50, at a part of the outer surface 21 of the base body 20, including the first end surface 22A. Specifically, the first underlying electrode 61A is a five-face electrode that covers the first end surface 22A of the base body 20 and parts of the four side surfaces 22C thereof in the first positive direction X1. According to this embodiment, the material of the first underlying electrode 61A is a mixture of silver and glass.

The first metal layer 61B covers the first underlying electrode 61A from the outside. Thus, the first metal layer 61B is stacked on the first underlying electrode 61A. Although not shown in the drawing, the first metal layer 61B has a two-layer structure of a nickel layer and a tin layer in this order from the first underlying electrode 61A.

The second external electrode 62 includes a second underlying electrode 62A and a second metal layer 62B. The second underlying electrode 62A is stacked on the glass film 50, at a part of the outer surface 21 of the base body 20, including the second end surface 22B. Specifically, the second underlying electrode 62A is a five-face electrode that covers the second end surface 22B of the base body 20 and parts of the four side surfaces 22C thereof in the first negative direction X2. According to this embodiment, the material of the second underlying electrode 62A is the same as the material of the first external electrode 61, and is a mixture of silver and glass.

The second metal layer 62B covers the second underlying electrode 62A from the outside. Thus, the second metal layer 62B is stacked on the second underlying electrode 62A. Specifically, as with the first metal layer 61B, the second metal layer 62B has a two-layer structure of a nickel layer and a tin layer.

The second external electrode 62 is, without reaching the first external electrode 61 on the side surface 22C, disposed away from the first external electrode 61 in the direction along the first axis X. Further, on the side surface 22C of the base body 20, the first external electrode 61 or the second external electrode 62 is not stacked in a central part in the direction along the first axis X, and the glass film 50 is exposed. It is to be noted that the first external electrode 61 and the second external electrode 62 are indicated by two-dot chain lines in FIGS. 1 and 2.

The first external electrode 61 and the end of the first internal electrode 41 in the first positive direction X1 are connected via a first penetrating part 71 penetrating the glass film 50. Although details will be described later, the first penetrating part 71 is formed by extension of palladium constituting the first internal electrode 41 toward the first external electrode 61 in the process of manufacturing the electronic component 10.

In addition, the second external electrode 62 and the end of the second internal electrode 42 in the first negative direction X2 are connected via a second penetrating part 72 penetrating the glass film 50. As with the first penetrating part 71, the second penetrating part 72 is also formed by extension of palladium constituting the second internal electrode 42 toward the second external electrode 62 in the process of manufacturing the electronic component 10. Although the first internal electrode 41 and the first penetrating part 71 are illustrated as separate members with a boundary In FIG. 2, there is actually no clear boundary therebetween. In this respect, the same applies to the second penetrating part 72. In addition, the illustration of the first penetrating part 71 and second penetrating part 72 is omitted in FIG. 1.

### (As for Recess of Base Body)

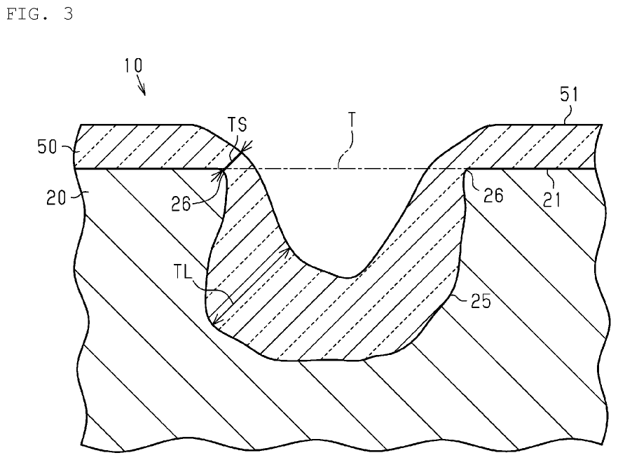

As shown in FIG. 3, the outer surface 21 of the base body 20 has one or more recesses 25. The recess 25 is recessed toward the inside of the base body 20 with respect to the periphery. In addition, the glass film 50 described above also covers the recess 25 of the outer surface 21. Further, the glass film 50 follows the recessed shape of the recess 25 to some extent. More specifically, a part of the outer surface 51 of the glass film 50 that covers the recess 25 is recessed toward the base body 20 side with respect to the periphery.

Further, opening edges 26 of the recess 25 are defined as follows. First, a section of one recess 25 is viewed at a plane that is orthogonal to the outer surface 21. Then, a tangent line T that circumscribes both sides of the outer surface 21 with the recess 25 interposed therebetween is drawn on the section. In this regard, a part of the tangent line T may coincide with the outer surface 21. Then, of the tangent points between the tangent line T and the outer surface 21, the ends of the recess 25 closer to the center are defined as the opening edges 26.

The ratio of the minimum value TS of the thickness of the glass film 50 covering the recess 25 to the maximum value TL of the thickness thereof is 0.05 to 0.8. In this regard, the thickness of the glass film 50 is calculated as follows. First, a section that is orthogonal to the outer surface 21 of the electronic component 10 is photographed with an electron microscope. Then, the shortest distance from one arbitrary point on the recess 25 to the outer surface 51 of the glass film 50 is calculated in the photographed image. This distance is regarded as the thickness of the glass film 50 covering one arbitrary point on the recess 25. Then, on an image captured with the electron microscope, the thickness of the glass film 50 covering the recess 25 is measured within the range from one of the opening edges 26 of the recess 25 to the other opening edge 26 thereof. Among the measurement values thus obtained, the maximum value TL and the minimum value TS are specified. It is to be noted that the maximum value TL is measured at or near the deepest part of the recess 25. In contrast, the minimum value TS is measured at or near the opening edge 26 of the recess 25. As described above, the value of “minimum value TS/maximum value TL” is 0.05 to 0.8. Specifically, in the example shown in FIG. 3, the value of “minimum value TS/maximum value TL” is about 0.24.

### (As for Method for Manufacturing Electronic Component)

Next, a method for manufacturing the electronic component 10, including a method for forming the glass film 50 on the base body 20, will be described.

As shown in FIG. 4, the method for manufacturing the electronic component 10 includes a laminated body preparing step S11, a round chamfering step S12, a solvent charging step S13, a catalyst charging step S14, a base body charging step S15, a polymer charging step S16, and a metal alkoxide charging step S17. In addition, the method for manufacturing the electronic component 10 further includes a film forming step S18, a first drying step S19, an immersing step S20, a second drying step S21, a conductor applying step S22, a curing step S23, and a plating step S24.

First, for forming the base body 20, a laminated body that is the base body 20 without the boundary surfaces 23 or the corner surfaces 24 is prepared in the laminated body preparing step S11. More specifically, the laminated body, which is subjected to no round chamfering, has a rectangular parallelepiped shape with the six flat faces 22. For example, first, a plurality of ceramic sheets to serve as the base body 20 are prepared. The sheets each has a thin plate shape. On the sheet, a conductive paste to serve as the first internal electrode 41 is stacked. On the laminated paste, the ceramic sheet to serve as the base body 20 is stacked. On the sheet, a conductive paste to serve as the second internal electrode 42 is stacked. In this manner, the ceramic sheet and the conductive paste are stacked. Then, an unfired stacked body is formed by cutting into a predetermined size. Thereafter, the unfired stacked body is subjected to firing at a high temperature to provide a laminated body.

Next, as shown in FIG. 4, the round chamfering step S12 is performed. In the round chamfering step S12, the boundary surfaces 23 and the corner surfaces 24 are formed for the laminated body prepared in the laminated body preparing step S11. For example, the corners of the laminated body is subjected to round chamfering by barrel polishing to form the boundary surfaces 23 with curved surfaces and the corner surfaces 24 with curved surfaces. Thus, the base body 20 is formed. Further, in the process of barrel polishing, base bodies 20 can collide with each other, thereby forming the recesses 25 at the outer surface 21 of the base body 20. In addition, when there is any part that is not subjected to the barrel polishing at the outer surface 21 of the base body 20, the irregularities of the part will remain as recesses 25 also after the barrel polishing. Furthermore, when the outer surface 21 of the base body 20 is not sufficiently polished by the barrel polishing, the irregularities of the outer surface 21 of the base body 20 formed before the barrel polishing may remain as recesses 25, without being perfectly polished.

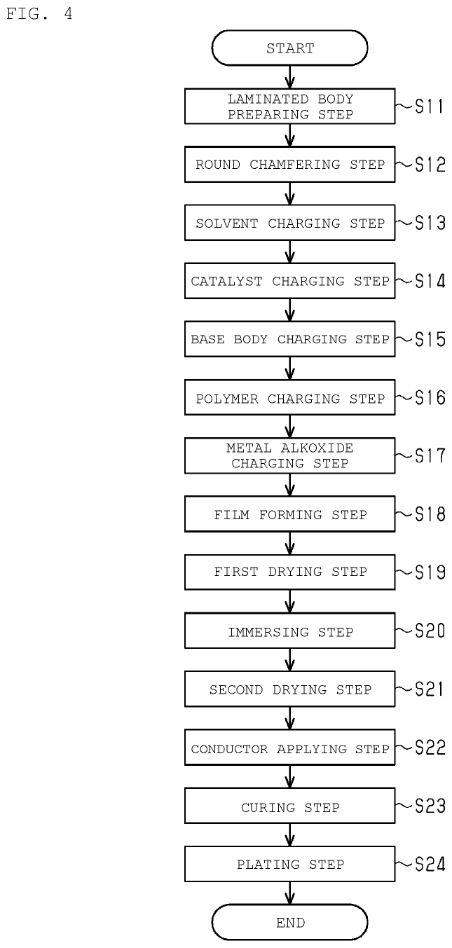

Next, as shown in FIG. 4, the solvent charging step S13 is performed. As shown in FIG. 5, in the solvent charging step S13, 2-propanol is put as a solvent 82 into a reaction vessel 81.

Next, as shown in FIG. 4, the catalyst charging step S14 is performed. As shown in FIG. 6, in the catalyst charging step S14, first, the solvent 82 in the reaction vessel 81 is stirred. Then, as an aqueous solution 83 containing a catalyst, ammonia water is put into the reaction vessel 81. The catalyst in this embodiment, which is a hydroxide ion, functions as a catalyst that promotes hydrolysis of a metal alkoxide 85 described later.

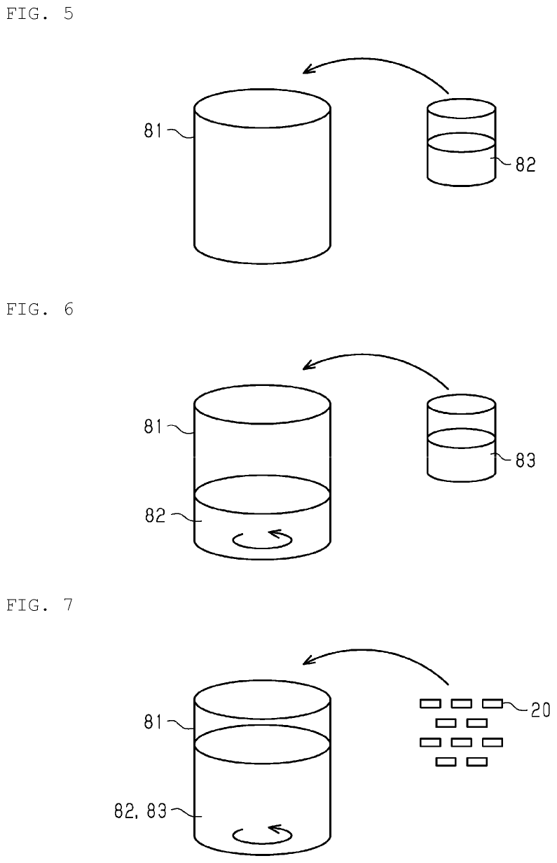

Next, as shown in FIG. 4, the base body charging step S15 is performed. As shown in FIG. 7, in the base body charging step S15, a plurality of base bodies 20 formed in advance in the round chamfering step S12 as described above are put into the reaction vessel 81.

Next, as shown in FIG. 4, the polymer charging step S16 is performed. As shown in FIG. 8, in the polymer charging step S16, a polyvinylpyrrolidone is put as a polymer 84 into the reaction vessel 81. Thus, the polymer 84 put into the reaction vessel 81 adsorbs to the outer surfaces 21 of the base bodies 20.

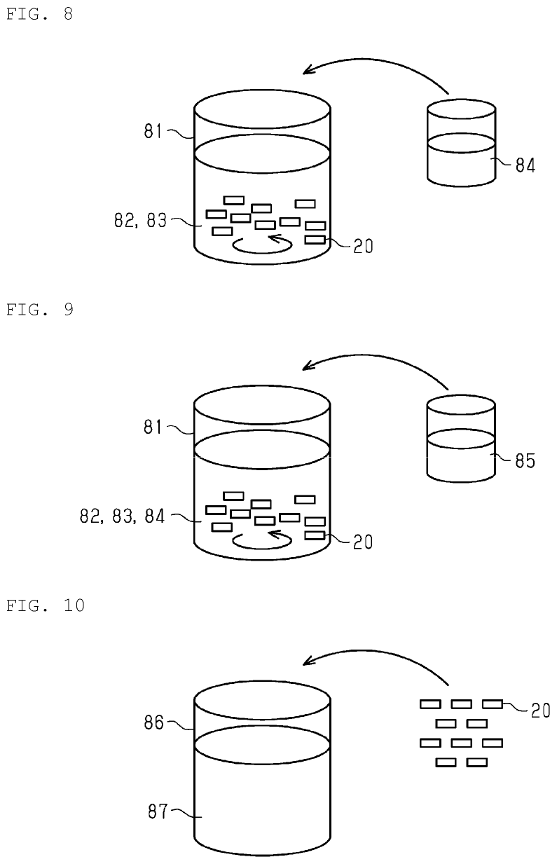

Next, as shown in FIG. 4, the metal alkoxide charging step S17 is performed. As shown in FIG. 9, in the metal alkoxide charging step S17, a liquid tetraethyl orthosilicate is put as the metal alkoxide 85 into the reaction vessel 81. It is to be noted that the tetraethyl orthosilicate may be referred to as a tetraethoxysilane. In the present embodiment, the amount of the metal alkoxide 85 put in the metal alkoxide charging step S17 is calculated, based on the area of the outer surfaces 21 of the base bodies 20 put in the base body charging step S15. Specifically, the calculation is performed by multiplying the amount of the metal alkoxide 85 per base body 20, required for forming the glass film 50 covering the outer surface 21 of the base body 20, by the number of base bodies 20.

Next, as shown in FIG. 4, the film forming step S18 is performed. In the film forming step S18, the stirring of the solvent 82, started in the solvent charging step S13 described above, is continued for a predetermined time, after the metal alkoxide 85 is put into the reaction vessel 81 in the metal alkoxide charging step S17. Thus, the metal alkoxide 85 is hydrolyzed with the hydroxide ion as a catalyst. When the metal alkoxide 85 is hydrolyzed, the hydrolyzed metal alkoxide 85 adheres to the surfaces of the base bodies 20. Then, the metal alkoxides 85 adhering to the surfaces of the base bodies 20 are dehydrated and condensed to form the glass film 50. In the film forming step S18, the glass film 50 in a sol form is formed by a liquid phase reaction in the reaction vessel 81.

Next, as shown in FIG. 4, the first drying step S19 is performed. In the first drying step S19, the base bodies 20 are, after the film forming step S18, taken out from the reaction vessel 81 and then dried. Thus, the glass film 50 in the sol form is dried to become a glass film 50 in a gel form.

Next, as shown in FIG. 4, the immersing step S20 is performed. As shown in FIG. 10, in the immersing step S20, first, a solution 87 containing, as an additive, at least one element selected from an alkali metal and an alkaline earth metal is placed in advance in a reaction vessel 86 that is different from the reaction vessel 81 used up to the film forming step S18. In the present embodiment, the solution 87 is an aqueous solution containing a potassium oxide precursor. Then, the base bodies 20 with the glass film 50 in the gel form is immersed in the solution 87. Thus, the solution 87 adheres to the surface of the glass film 50.

Next, as shown in FIG. 4, the second drying step S21 is performed. In the second drying step S21, the base bodies 20 immersed in the solution 87 in the immersing step S20 are taken out from the reaction vessel 86 and then dried. Thus, the water of the solution 87 adhering to the surface of the glass film 50 is volatilized. In contrast, the potassium oxide precursor included in the solution 87 is deposited on the outer surface 51 of the glass film 50.

Next, the conductor applying step S22 is performed. In the conductor applying step S22, a conductor paste is applied to two parts of the surface of the glass film 50: a part including a part that covers the first end surface 22A of the base body 20; and a part including a part that covers the second end surface 22B of the base body 20.

Specifically, the conductor paste is applied so as to cover the glass film 50 on the whole region of the first end surface 22A and parts of the four side surfaces 22C. In addition, the conductor paste is applied so as to cover the glass film 50 on the whole region of the second end surface 22B and parts of the four side surfaces 22C.

Next, the curing step S23 is performed. Specifically, the base bodies 20 with the glass film 50 and conductor paste applied thereto are heated in the curing step S23. Thus, the deposited potassium oxide precursor becomes potassium oxide. The potassium oxide diffuses into the glass film 50 covering the outer surface 21 of the base body 20. Then, the vaporization of water and the polymer 84 from the glass film 50 in the gel form causes the glass film 50 covering the outer surface 21 of the base body 20 to be fired and cured. Furthermore, in the curing step S23, the conductor paste applied in the conductor applying step S22 is fired to form the first underlying electrode 61A and the second underlying electrode 62A.

In the present embodiment, at the time of heating in the curing step S23, the palladium contained on the side with the first internal electrodes 41 is attracted toward the side with first underlying electrode 61A containing silver by the Kirkendall effect caused from the difference in diffusion rate between the first internal electrodes 41 and the first underlying electrode 61A. Thus, the first penetrating parts 71 penetrate and extend through the glass film 50 from the first internal electrodes 41 toward the first underlying electrode 61A, thereby connecting the first internal electrodes 41 and the first underlying electrode 61A to each other. In this respect, the same applies to the second penetrating parts 72 that connect the second internal electrodes 42 and the second underlying electrode 62A to each other.

Next, the plating step S24 is performed. Parts of the first underlying electrode 61A and second underlying electrode 62A are subjected to electroplating. Thus, the first metal layer 61B is formed on the surface of the first underlying electrode 61A. In addition, the second metal layer 62B is formed on the surface of the second underlying electrode 62A. Although not illustrated, the first metal layer 61B and the second metal layer 62B each have a two-layer structure with two kinds of nickel and tin electroplated. In this manner, the electronic component 10 is formed.

### (As for Effects of Embodiment)

(1) According to the embodiment mentioned above, the ratio of the minimum value TS of the thickness of the glass film 50 covering the recess 25 to the maximum value TL thereof is 0.05 to 0.8. In this regard, the glass film 50 covering the recess 25 has a maximum thickness at a site that covers the vicinity of the deepest part of the recess 25. In contrast, the glass film 50 covering the recess 25 has a minimum thickness at a site that covers the vicinity of the opening edge 26 of the recess 25. More specifically, the change in the thickness of the glass film 50 covering the recess 25 is not sharp from the deepest part of the recess 25 to the opening edge 26 of the recess 25. Accordingly, the glass film 50 covering the recess 25 can be prevented from being cracked or the like.

(2) In the embodiment mentioned above, the softening point of the glass film 50 is lowered as compared with a case where the glass film 50 contains no alkali metal or alkaline earth metal. Thus, the glass melted in curing step S23 is likely to reach the inside of recess 25. As a result, a part of the recess 25 can be filled with the glass film 50, thereby increasing the flatness of the outer surface 51 of the glass film 50.

(3) According to the embodiment mentioned above, the glass film 50 contains an alkali metal or an alkaline earth metal, and the ratio of the alkali metal or alkaline earth metal to Si contained in the glass film 50 is 0.5 atm % to 90 atm %. The glass film 50 contains therein the alkali metal or the alkaline earth metal within this range of ratio, thereby making it easy to control the ratio of the minimum value TS of the thickness of the glass film 50 covering the recess 25 to the maximum value TL thereof to be 0.05 to 0.8.

(4) According to the embodiment mentioned above, the glass film 50 containing an alkali metal or an alkaline earth metal as an additive can be formed through the immersing step S20 and the second drying step S21 after the film forming step S18 and the first drying step S19. Further, the immersing step S20 and the second drying step S21 can be simply performed without requiring any special apparatus or the like. Accordingly, the manufacturing method according to the embodiment mentioned above can be achieved without any significant change from the conventional manufacturing process.

### OTHER EMBODIMENTS

The embodiment mentioned above can be modified as below and then implemented. The above-mentioned embodiment and the following modification examples can be implemented in combination within a range that is not technically contradictory.

In the embodiment mentioned above, the electronic component 10 is not limited to any negative characteristic thermistor component. For example, the electronic component 10 may be a thermistor component other than those that have negative characteristics, or may be a multilayer capacitor component or an inductor component, as long as the component includes some wiring inside the base body 20.

The material of the base body 20 is not limited to the example of the embodiment mentioned above. The material of the base body 20 may be a composite of a resin and a metal powder.

The shape of the base body 20 is not limited to the example of the embodiment mentioned above. For example, the base body 20 may have a polygonal columnar shape other than the quadrangular columnar shape with the central axis CA. In addition, the base body 20 may be a core of a wire-wound inductor component. For example, the core may have a so-called a drum core shape. Specifically, the core may have a columnar winding core part and a flange part provided at each end of the winding core part.

The outer surface 21 of the base body 20 may have no boundary surface 23 or corner surface 24. For example, when the boundary between the adjacent flat faces 22 of the outer surface 21 of the base body 20 has no chamfered shape, the boundary has no curved surface. Thus, in such a case, there may be no boundary surface 23 or corner surface 24.

In the embodiment mentioned above, the shapes of the first internal electrodes 41 and second internal electrodes 42 are not restricted as long as the shapes can ensure electrical conduction with the corresponding first external electrode 61 and second external electrode 62. In addition, the numbers of the first internal electrodes 41 and second internal electrodes 42 are not limited, and the numbers of the internal electrodes may be one or may be three or more.

The configuration of the first external electrode 61 is not limited to the example of the embodiment mentioned above. For example, the first external electrode 61 may include only the first underlying electrode 61A, or the first metal layer 61B may have no two-layer structure. In this respect, the same applies to the second external electrode 62.

In the embodiment mentioned above, the combination of the materials of the first internal electrodes 41 and the first underlying electrode 61A is not limited to the combination of palladium and silver. For example, the combination may be a combination of copper and nickel, copper and silver, silver and gold, nickel and cobalt, or nickel and gold may. For example, the combination may have: silver as one of the materials; and a combination of silver and palladium as the other. For example, the combination may have: palladium as one of the materials; and a combination of silver and palladium as the other, or the combination may have: copper as one of the materials; and a combination of silver and palladium as the other. For example, the combination may have: gold as one of the materials; and a combination of silver and palladium as the other.

It is to be noted that depending on the combination of the first internal electrodes 41 and the first underlying electrode 61A, the Kirkendall effect may not be obtained. In this case, the first internal electrodes 41 may be processed to be exposed before the external electrode forming step. For example, a part of the glass film 50 may be physically removed by polishing the side of the base body 20 closer to the first end surface 22A. Thereafter, the first internal electrodes 41 and the first underlying electrode 61A can be connected by performing the underlying electrode forming step. Alternatively, for example, after the first underlying electrode 61A is formed, the glass film 50 may be formed on a region including the surface of the first underlying electrode 61A, and the glass film 50 covering the surface of the first underlying electrode 61A may be removed. In this respect, the same applies to the combination of the materials of the second internal electrodes 42 and second underlying electrode 62A.

The site where the first external electrode 61 is disposed is not limited to the example of the embodiment mentioned above. For example, the first external electrode 61 may be disposed only on the first end surface 22A and one of side surfaces 22C. In this respect, the same applies to the second external electrode 62.

The glass film 50 may optionally cover the whole region of the outer surface 21 of the base body 20. The range covered by the glass film 50 may be appropriately changed in accordance with the shape of the base body 20, the positions of the first external electrode 61 and second external electrode 62, and the like.

As for the part of the glass film 50 covered with the first underlying electrode 61A, the glass in the glass film 50 may be diffused into and thus integrated with glass in the first underlying electrode 61A.

When the ratio of the minimum value TS of the thickness of the glass film 50 covering the recess 25 to the maximum value TL thereof is 0.05 to 0.8, the glass film 50 can be prevented from being cracked or the like. Thus, the glass film 50 may optionally contain, as an additive, one or more elements selected from alkali metals and alkaline earth metals.

When the glass film 50 contains, as an additive, one or more elements selected from alkali metals and alkaline earth metals, the ratio of the additive to Si contained in the glass film 50 may be less than 0.5 atm % or more than 90 atm %.

The material of the glass film 50 is not limited to the example of the embodiment mentioned above. For example, the glass is not limited to any silicon dioxide, and may be a multicomponent oxide containing Si, such as a B—Si-based, Si—Zn-based, Zr—Si-based, or Al—Si-based oxide. In addition, the glass may be a multicomponent oxide containing an alkali metal and Si, such as an Al—Si-based, Na—Si-based, or Li—Si-based oxide. Furthermore, the glass may be a multicomponent oxide containing an alkaline earth metal and Si, such as an Mg—Si-based, Ca—Si-based, Ba—Si-based, or Sr—Si-based oxide. Further, the glass may contain no Si, and may be a mixture thereof.

The material of the glass film 50 may contain, in addition to the glass, a surface treatment agent or an antistatic agent, such as a pigment, a silicone-based flame retardant, a silane coupling agent, or a titanate coupling agent.

More specifically, the glass film 50 may contain, in addition to the glass, additives of fine particles and nanoparticles of organic acid salts, oxides, inorganic salts, organic salts, and other metal oxides. In addition, the additive contained in the solution 87 is not limited to the potassium oxide precursor.

Examples of the organic acid salts include salts of oxo acids, such as soda ash, sodium carbonate, sodium hydrogen carbonate, sodium percarbonate, sodium sulfite, sodium hydrogen sulfite, sodium sulfate, sodium thiosulfate, sodium nitrate, and sodium sulfite, and halogen compounds such as sodium fluoride, sodium chloride, sodium bromide, and sodium iodide.

Examples of the oxides include sodium peroxide, and examples of the hydroxides include sodium hydroxide.

Examples of the inorganic salts include sodium hydride, sodium sulfide, sodium hydrogen sulfide, sodium silicate, trisodium phosphate, sodium borate, sodium borohydride, sodium cyanide, sodium cyanate, and sodium tetrachloroaurate.

In addition, examples of the inorganic salts include calcium peroxide, calcium hydroxide, calcium fluoride, calcium chloride, calcium bromide, calcium iodide, calcium hydride, calcium carbide, and calcium phosphide.

The additive may be an oxoacid salt such as calcium carbonate, calcium hydrogen carbonate, calcium nitrate, calcium sulfate, calcium sulfite, calcium silicate, calcium phosphate, calcium pyrophosphate, calcium hypochlorite, calcium chlorate, calcium perchlorate, calcium bromate, calcium iodate, calcium arsenite, calcium chromate, calcium tungstate, calcium molybdate, calcium magnesium carbonate, or hydroxyapatite. In addition, examples of the additive include calcium acetate, calcium gluconate, calcium citrate, calcium malate, calcium lactate, calcium benzoate, calcium stearate, and calcium aspartate.

For example, the additive may be lithium carbonate, lithium chloride, lithium titanate, lithium nitride, lithium peroxide, lithium citrate, lithium fluoride, lithium hexafluorophosphate, lithium acetate, lithium iodide, lithium hypochlorite, lithium tetraborate, lithium bromide, lithium nitrate, lithium hydroxide, lithium aluminum hydride, lithium triethylborohydride, lithium hydride, lithium amide, lithium imide, lithium diisopropylamide, lithium tetramethylpiperide, lithium sulfide, lithium sulfate, lithium thiophenolate, or lithium phenoxide.

For example, the additive may be boron triiodide, sodium cyanoborohydride, sodium borohydride, tetrafluoroboric acid, triethylborane, borax, or boric acid.

For example, the additive may be barium sulfite, barium chloride, barium chlorate, barium perchlorate, barium peroxide, barium chromate, barium acetate, barium cyanide, barium bromide, barium oxalate, barium nitrate, barium hydroxide, barium hydride, barium carbonate, barium iodide, barium sulfide, or barium sulfate. Additionally, the additive may be sodium acetate or sodium citrate.

The additive may be fine particles or nanoparticles of a metal oxide, and examples of the metal oxide include sodium oxide, calcium oxide, lithium oxide, boron oxide, barium oxide, silicon oxide, titanium oxide, zircon oxide, aluminum oxide, zinc oxide, and magnesium oxide.

In addition, in the embodiment mentioned above, examples of the potassium oxide precursor include potassium arsenide, potassium bromide, potassium carbide, potassium chloride, potassium fluoride, potassium hydride, potassium iodide, potassium triiodide, potassium azide, potassium nitride, potassium superoxide, potassium ozonide, potassium peroxide, potassium phosphide, potassium sulfide, potassium selenide, potassium telluride, potassium tetrafluoroaluminate, potassium tetrafluoroborate, potassium tetrahydroborate, potassium methanide, potassium cyanide, potassium formate, potassium hydrogen fluoride, potassium tetraiodomercurate (II), potassium hydrogen sulfide, potassium octachlorodimolybdate (II), potassium amide, potassium hydroxide, potassium hexafluorophosphate, potassium carbonate, potassium tetrachloroplatinate (II), potassium hexachloroplatinate (IV), potassium nonahydridorhenate (VII), potassium sulfate, potassium acetate, gold (I) potassium cyanide, potassium hexanitritocobaltate (III), potassium hexacyanoferrate (III), potassium hexacyanoferrate (II), potassium methoxide, potassium ethoxide, potassium tert-butoxide, potassium cyanate, potassium fulminate, potassium thiocyanate, potassium aluminum sulfate, potassium aluminate, potassium arsenate, potassium bromate, potassium hypochlorite, potassium chlorite, potassium chlorate, potassium perchlorate, potassium carbonate, potassium chromate, potassium dichromate, potassium tetrakis(peroxo) chromate (V), potassium cuprate (III), potassium ferrate, potassium iodate, potassium periodate, potassium permanganate, potassium manganate, potassium hypomanganate, potassium molybdate, potassium nitrite, potassium nitrate, tripotassium phosphate, potassium perrhenate, potassium selenate, potassium silicate, potassium sulfite, potassium sulfate, potassium thiosulfate, potassium disulfite, potassium dithionate, potassium disulfate, potassium peroxodisulfate, potassium dihydrogenarsenate, dipotassium hydrogen arsenate, potassium hydrogen carbonate, potassium dihydrogen phosphate, dipotassium hydrogen phosphate, potassium hydrogen selenate, potassium hydrogen sulfite, potassium hydrogen sulfate, and potassium hydrogen peroxosulfate.

The metal alkoxide 85 may be, for example, sodium methoxide, sodium ethoxide, calcium diethoxide, lithium isopropoxide, lithium ethoxide, lithium tert-butoxide, lithium methoxide, boron alkoxides, potassium t-butoxide, tetraethyl orthosilicate, allyltrimethoxysilane, isobutyl(trimethoxy) silane, tetrapropyl orthosilicate, tetramethyl orthosilicate, [3-(diethylamino) propyl]trimethoxysilane, triethoxy (octyl) silane, triethoxyvinylsilane, triethoxyphenylsilane, trimethoxyphenylsilane, trimethoxymethylsilane, butyltrichlorosilane, n-propyltriethoxysilane, methyltrichlorosilane, dimethoxy(methyl) octylsilane, dimethoxydimethylsilane, tris(tert-butoxy) silanol, tris(tert-pentoxy) silanol, hexadecyltrimethoxysilane, dipotassium tris(1,2-benzenediolato-O,O′) silicate, tetrabutyl orthosilicate, aluminum silicate, calcium silicate, a tetramethylammonium silicate solution, chlorotriisopropoxytitanium (IV), titanium (IV) isopropoxide, titanium (IV) 2-ethylhexyl oxide, titanium (IV) ethoxide, titanium (IV) butoxide, titanium (IV) tert-butoxide, titanium (IV) propoxide, titanium (IV) methoxide, zirconium (IV) bis(diethyl citrato)dipropoxide, zirconium (IV) dibutoxide (bis-2,4-pentanedionate), zirconium (IV) 2-ethylhexanoate, a zirconium (IV) isopropoxide isopropanol complex, zirconium (IV) ethoxide, zirconium (IV) butoxide, zirconium (IV) tert-butoxide, zirconium (IV) propoxide, aluminum tert-butoxide, aluminum isopropoxide, aluminum ethoxide, aluminum-tri-see-butoxide, or aluminum phenoxide.

In the method for manufacturing the electronic component 10 according to the embodiment mentioned above, a metal complex or an acetate as a precursor for the metal alkoxide 85 may be used instead of the metal alkoxide 85. In this case, in the metal alkoxide charging step S17, the metal complex or acetate as a metal alkoxide precursor may be put. Examples of the metal complex include acetylacetonates such as lithium acetylacetonate, titanium (IV) oxyacetylacetonate, titanium diisopropoxide bis(acetylacetonate), zirconium (IV) trifluoroacetylacetonate, zirconium (IV) acetylacetonate, aluminum acetylacetonate, aluminum (III) acetylacetonate, calcium (II) acetylacetonate, and zinc (II) acetylacetonate. In addition, examples of the acetate include zirconium acetate, zirconium (IV) acetate hydroxide, and basic aluminum acetate.

The solvent 82 put in the solvent charging step S13 is not limited to the example of the embodiment mentioned above, and may be any liquid that can disperse the metal alkoxide 85 appropriately.

In the embodiment mentioned above, the solvent charging step S13 may be performed after the catalyst charging step S14 and the base body charging step S15. The solvent charging step S13 may be performed before at least any one of the metal alkoxide charging step S17 and the catalyst charging step S14. In addition, the solvent charging step S13 may be omitted. In this case, for example, when the amount of water contained in the aqueous solution 83 containing the catalyst is appropriately large, the metal alkoxide 85 reacts in the liquid phase. In addition, the aqueous solution 83 containing the catalyst, mixed with an organic solvent as the solvent 82, may be put.

In the embodiment mentioned above, the aqueous solution 83 containing the catalyst is ammonia water, and the catalyst is a hydroxide ion, but the catalyst is not limited thereto. As with the ammonia water according to the embodiment mentioned above, basic aqueous solutions are capable of catalyzing the hydrolysis of the metal alkoxide 85, and acidic aqueous solutions are also capable of catalyzing the hydrolysis of the metal alkoxide 85. Furthermore, neutral aqueous solutions may be also employed, as long as the aqueous solutions contain therein ions or the like capable of catalyzing the hydrolysis.

While the catalyst has been described as being put as the aqueous solution 83 containing the catalyst in the embodiment mentioned above, a solid compound containing the catalyst and water may be separately put into the reaction vessel 81, and in this case, the catalyst can be considered as being put in the reaction vessel 81, based on the fact that the catalyst is produced in the reaction vessel 81. In addition, for example, a solid compound containing the catalyst may be put into the reaction vessel 81, and moisture in the air may be used as water required for the hydrolysis.

In the embodiment mentioned above, the base body charging step S15 may be performed before the catalyst charging step S14. In addition, when the base body charging step S15 is performed before the catalyst charging step S14, the metal alkoxide charging step S17 may be performed before the catalyst charging step S14 or the base body charging step S15. The base body charging step S15 may be performed before at least any one of the metal alkoxide charging step S17 and the catalyst charging step S14.

In the embodiment mentioned above, in the metal alkoxide charging step S17, a solution containing a precursor for producing the metal alkoxide 85 may be put instead of the metal alkoxide 85. The metal alkoxide 85 may be produced in the reaction vessel 81, rather than producing the metal alkoxide 85 outside the reaction vessel 81 and then placing the metal alkoxide 85 into the reaction vessel 81. For example, the metal alkoxide 85 is produced by a reaction between a metal salt and an alcohol. Thus, the metal alkoxide 85 can be considered as being put in the reaction vessel 81, also based on the fact that the metal salt that is a metal alkoxide precursor and the alcohol are put into the reaction vessel 81 and then allowed to react with each other to produce the metal alkoxide 85.

In the embodiment mentioned above, the metal alkoxide 85 is not limited to any tetraethyl orthosilicate. For example, titanium, zirconium, aluminum, or the like may be used for the metal contained in the metal alkoxide 85. Further, when the metal contained in the metal alkoxide 85 is silicon, the reaction rate of the metal alkoxide 85 is easily controlled to be constant, because the reaction rate is lower than that of other metals. In addition, as for the alkoxy group of the metal alkoxide 85, a methoxy group, a propoxy group, or the like may be used, or a functional group such as a long-chain alkyl group or an epoxy group may be modified like a coupling agent. Furthermore, the coordination number with respect to the metal contained in the metal alkoxide 85 is not limited to being four-coordination, and may be three-coordination or two-coordination.

In the embodiment mentioned above, the reaction vessel 86 different from the reaction vessel 81 was used in the immersing step S20. The reaction vessel 81 used up to the film forming step S18 may be used, as long as the solution used up to the film forming step S18 in the reaction vessel 81 is removed and the solution 87 is newly put into the reaction vessel 81.

In the embodiment mentioned above, in the immersing step S20, the solution 87 has only to adhere to the glass film 50 covering the outer surface 21 of the base body 20, and thus, the base body 20 may be optionally immersed in the solution 87 in the reaction vessel 86. For example, the solution 87 may be applied only to the part covered with the glass film 50 at the outer surface 21 of the base body 20.

In the embodiment mentioned above, the curing step S23 is not limited to the step of simultaneously curing the glass film 50 and the conductor paste. For example, as long as the conductor paste is a material that is cured by ultraviolet irradiation, a heating step may be performed as a curing step of curing the glass film 50, and ultraviolet irradiation may be performed as a step of curing the conductor paste.

### DESCRIPTION OF REFERENCE SYMBOLS

10: Electronic component
20: Base body
21: Outer surface
25: Recess
50: Glass film
81: Reaction vessel
83: Aqueous solution
85: Metal alkoxide
86: Reaction vessel
87: Solution
S14: Catalyst charging step
S15: Base body charging step
S17: Metal alkoxide charging step
S18: Film forming step
S19: First drying Step
S20: Immersing step
S21: Second drying Step
S23: Curing step
TL: Maximum value
TS: Minimum value

1. An electronic component comprising:
a base body having an outer surface, and the outer surface having a recess that is a site recessed with respect to a periphery of the outer surface; and
a glass film that covers at least a portion of the outer surface of the base body having the recess, wherein a part of the glass film that covers the recess is recessed with respect to the periphery of the outer surface of the glass film, and
a ratio of a minimum value of a thickness of the glass film covering the recess to a maximum value of the thickness is 0.05 to 0.8.

2. The electronic component according to claim 1, wherein the glass film contains, as an additive, one or more elements selected from alkali metals and alkaline earth metals.

3. The electronic component according to claim 2, wherein a ratio of the additive to Si contained in the glass film is 0.5 atm % to 90 atm %.

4. The electronic component according to claim 1, wherein the glass film covers an entirety of the outer surface of the base body.

5. The electronic component according to claim 1, wherein a material of the glass film contains silicon dioxide, a multicomponent oxide containing Si, a multicomponent oxide containing an alkali metal and Si, or a multicomponent oxide containing an alkaline earth metal and Si.

6. A film forming method for forming a glass film containing a metal oxide on a surface of a base body, the method comprising:
placing a base body into a reaction vessel;
placing a metal alkoxide or a metal alkoxide precursor into the reaction vessel;
placing a catalyst that promotes hydrolysis of the metal alkoxide into the reaction vessel;
forming the glass film on the surface of the base body by hydrolyzing and dehydrating and condensing the metal alkoxide;
a first drying of the glass film after the forming of the glass film;
immersing the base body in a solution of an additive containing at least one element selected from an alkali metal and an alkaline earth metal after the first drying of the glass film;
a second drying of the glass film after the immersing of the base body in the solution; and
curing the glass film by firing the glass film after the second drying of the glass film.

7. The film forming method according to claim 6, wherein
an outer surface of the base body has a recess that is a site recessed with respect to a periphery of the outer surface,
the glass film covers at least the portion of the outer surface of the base body having the recess,
a part of the glass film that covers the recess is recessed with respect to the periphery of the outer surface of the glass film, and
a ratio of a minimum value of a thickness of the glass film covering the recess to a maximum value of the thickness is 0.05 to 0.8.

8. The film forming method according to claim 7, wherein the glass film covers an entirety of the outer surface of the base body.

9. The film forming method according to claim 6, wherein a material of the glass film contains silicon dioxide, a multicomponent oxide containing Si, a multicomponent oxide containing an alkali metal and Si, or a multicomponent oxide containing an alkaline earth metal and Si.
